(19) United States
(12) Patent Application Publication
(10) Pub. No.: US 2017/0130980 A1
(43) Pub. Date: May 11, 2017

(54) AUTOMATIC CONTROL METHOD FOR ZONE CONTROLLER

(71) Applicant: DELTA ELECTRONICS, INC., Taoyuan County (TW)

(72) Inventors: Tien-Szu LO, Taoyuan County (TW); Meng-Seng CHEN, Taoyuan County (TW)

(21) Appl. No.: 15/171,352

(22) Filed: Jun. 2, 2016

(30) Foreign Application Priority Data
Nov. 5, 2015 (CN) 201510744968.X

(51) Int. Cl. F24F 11/00; G05B 11/01; F24F 3/044

(52) U.S. Cl. CPC F24F 11/006; F24F 3/044; F24F 11/0012; F24F 11/0034; G05B 11/01; F24F 2011/0046; F24F 2011/0049; F24F 2011/0057; F24F 2011/0063; F24F 2011/0067; F24F 2011/0068

(57) ABSTRACT

An automatic control method for zone controller adopted by a zone controller connected to multiple sensors and multiple apparatus controllers in an indoor space is disclosed. The zone controller receives sense data of the sensors, and inquires an event-trigger table according to the sense data for determining if the current environment matches with a trigger condition of any predetermined event. When any event is triggered, the zone controller inquires a mode-switch table according to the triggered event for determining if the triggered event matches with any predetermined mode switch condition. When the triggered event matches with any mode switch condition, the zone controller automatically switches to a corresponding operation mode, and performs corresponding operation on the multiple apparatus controllers under the switched operation mode.

### BACKGROUND OF THE INVENTION

Field of the Invention

The present invention is related to a zone controller, in particular relates to an automatic control method for zone controller.

Description of Prior Art

In order to perform intelligent controls of a zone (for example a room, a meeting room or an office, etc.), the zone must have at least one zone controller (ZC) and multiple wireless nodes installed (for example, the wireless nodes can be the apparatus controllers for controlling indoor apparatus, or the sensors for sensing indoor and outdoor environment parameters). These sensors collects related data in the zone and provides the data to the ZC, whereby the ZC performs mode switch according to the data, and further performs corresponding controls over the apparatus controllers under different modes.

In general, a ZC works under several modes in related prior art, for example standby mode, full automation mode, semi-automation mode, etc. With the automatic switches among these modes, the ZC controls the apparatus controllers in the zone more efficiently, thus the apparatus controllers also control each indoor apparatus in the zone efficiently, for example a fan, an air conditioner, a blind, etc., to make the room in a comfortable status.

Though, the above mentioned modes were pre-defined when a ZC is in a factory, users are not allowed to make any changes. Accordingly, the judgment a ZC made in operations may not meet the demands of the users. In other words, the modes and the mode switch conditions may not satisfy the users.

For example, in a default setting of a ZC, when any light is turned on in a zone (i.e., the sense data of any light sensor is on), it is determined that there are people in the zone. As a result, the ZC automatically switches and operates under the full automation mode. However, some users have the habit to leave one light on when leaving a room, there is no one staying in the room. Under such circumstance, the automatic mode switching of the ZC does not meet user demands.

Further, in related prior art, the controls performed by ZC under each mode are also predetermined and users are not allowed to change. For example, if the full automation mode was pre-defined to operate when the environment temperature is higher than 27° C. in the zone (i.e., the sense data of a temperature sensor is higher than 27° C.), the ZC controls a fan in the zone by adjust the fan speed to HIGH. Under the circumstance, if the users preferred hotter or cooler environment, the above controls under the full automation mode of the ZC may not meet user demands.

### SUMMARY OF THE INVENTION

The primary objective of the present invention is to provide an automatic control method for zone controller. The method determines if the current environment status matches any predetermined mode switch condition according to sense data of a sensor, and ZC automatically performs operation mode switching when there is a match, thus performs corresponding operations on the apparatus controllers in an indoor space under different operation modes.

In order to achieve the above objective, the automatic control method is used in a ZC connected to multiple sensors and multiple apparatus controllers in an indoor space. The zone controller receives sense data of the sensors, and inquires an event-trigger table according to the sense data for determining if the current environment matches a trigger condition of any predetermined event. When any event is triggered, the zone controller inquires a mode-switch table according to the triggered event for determining if the triggered event matches with any predetermined mode switch condition. When the triggered event is determined matching with any mode switch condition, the zone controller automatically switches to corresponding operation mode, and performs corresponding operation on the multiple apparatus controllers under the switched operation mode.

The advantage provided by the method according to the present invention is that the ZC offers at least a self-configurable even-trigger table and at least a self-configurable mode-switch table, which are used for the user to set up multiple events, trigger conditions of each event, multiple operation modes and mode switch conditions of switching among each operation mode all by themselves. As a result, ZC has more diversified operation modes and meets the user true demands, and ZC is made more useful to users by performing automatic controls according to the self-configured operation modes.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a control system schematic diagram of the first embodiment according to the present invention;

FIG. 2 is a control system schematic diagram of the second embodiment according to the present invention;

FIG. 3 is a control system schematic diagram of the third embodiment according to the present invention;

FIG. 4 is a zone controller block diagram of the first embodiment according to the present invention;

FIG. 5 is a zone controller booting flowchart of the first embodiment according to the present invention;

FIG. 6 is a mode switch schematic diagram of the first embodiment according to the present invention;

FIG. 7 is a table set up flowchart of the first embodiment according to the present invention;

FIG. 8 is a table set up flowchart of the second embodiment according to the present invention;

FIG. 9 is an automatic control flowchart of the first embodiment according to the present invention;

FIG. 10 is an automatic operation flowchart of the first embodiment according to the present invention; and

FIG. 11 is a mode switch schematic diagram of the second embodiment according to the present invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

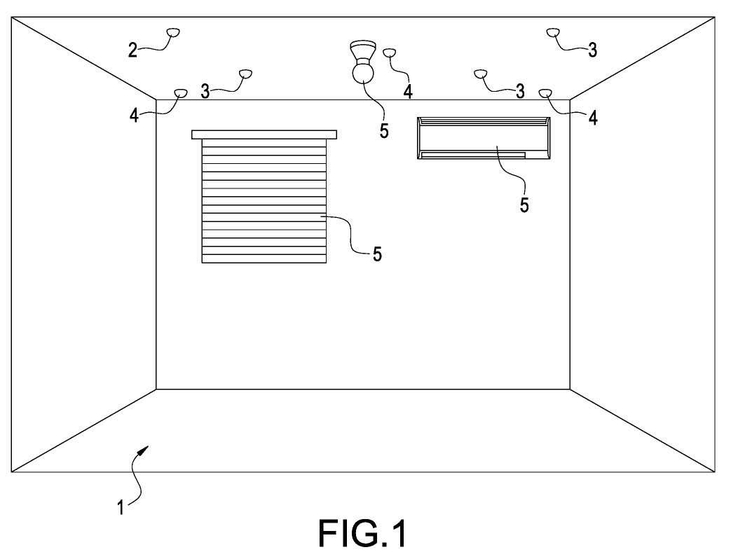

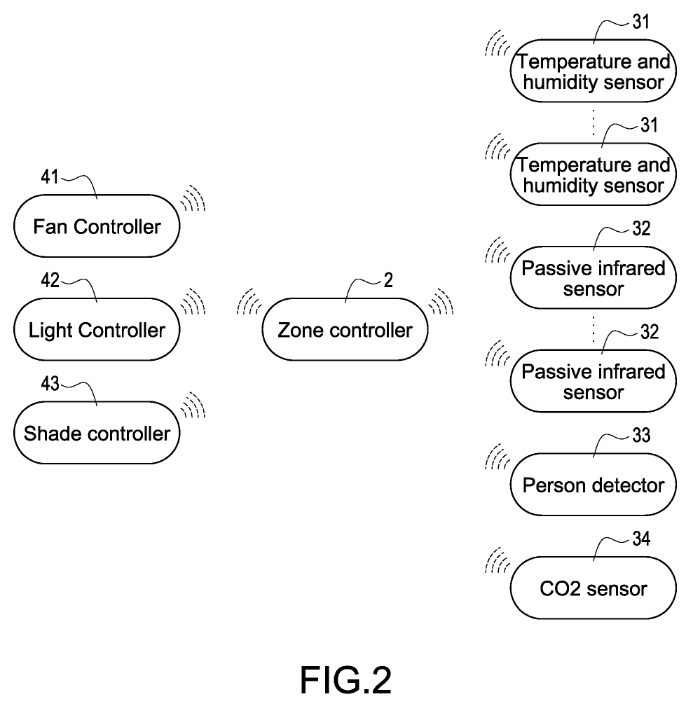

Refer to FIG. 1 and FIG. 2, FIG. 1 and FIG. 2 are respectively control system schematic diagrams of the first and the second embodiment according to the present invention. The present invention discloses an automatic control method for a zone controller, which is used for a zone controller (ZC) 2 disposed in an indoor space 1 (for example living room, bed room, meeting room or offices, etc.). In the embodiment, a plurality of sensors 3, a plurality of apparatus controllers 4 and a plurality of indoor apparatuses 5 are further disposed in the indoor space 1. The ZC 2 is respectively connected to the plurality of sensors 3 and the plurality of apparatus controllers 4 wired or wirelessly, the plurality of apparatus controllers 4 is connected with the plurality of indoor apparatuses 5 and controls the indoor apparatuses 5 respectively.

The plurality of sensors 3 are used for sensing the environment status in the indoor space 1. In the embodiment, the plurality of sensors 3 comprise a Temperature and Humidity Sensor (TH sensor) 31, a Passive Infrared Sensor (PIR sensor) 32, a Person Detector (PD) 33 and CO₂ sensor 34, etc., and the scope is not limited thereto. The TH sensor 31 is used for sensing indoor temperature in the indoor space 1 and outdoor humidity outside of the indoor space 1. The PIR sensor 32 and the PD 33 are used for sensing if there are people going in the indoor space 1. The CO₂ sensor 34 is used for sensing the CO₂ amount in the indoor space 1.

As shown in FIG. 1 and FIG. 2, In the embodiment, the plurality of indoor apparatuses 5 for example is at least one of a fan, an air conditioner, a light fixture and a blind, and the plurality of apparatus controllers 4 are used for controlling at least one of a Fan Controller (FC) 41 in the fan or the air conditioner, a Light Controller (LC) 42 for controlling the light fixture and a shade controller 43 for controlling the blind, but the scope is not limited thereto.

The ZC 2 operates under a specific operation mode, and performs operation on the plurality of apparatus controllers 4 according to operating rules of the operation mode. Whereby, each apparatus controller 4 performs corresponding control on each indoor apparatus 5 according to the ZC 2 in order to make the indoor space 1 a more comfortable environment to stay in.

In the technical solutions according to the present invention, the ZC 2 receives sense data generated by the plurality of sensors 3 sensing environment status in the indoor space 1, for example the temperature data, the humidity data, CO₂ amount data, person data, etc., and performs an analysis according to the sense data for determining if the sense data matches a predetermined mode switch condition. When the sense data is determined matching with the mode switch condition, the ZC 2 automatically switches to another corresponding operation mode, performs the operation under the switched operation mode, and performs corresponding operations on each apparatus controller 4 according to a plurality of operating rules under the switched operation mode.

With the above mentioned present invention technical solutions, the ZC 2 automatically switches among different operation modes according to the environment status in the indoor space 1, so as to perform operation on the apparatus controllers 4 based on different operating rules. As a result, the control performed by each apparatus controller 4 on each indoor apparatus 5 is highly associated by the environment status in the indoor space 1. Therefore, each indoor apparatus 5 more effectively improves environment comfort level in the indoor space 1.

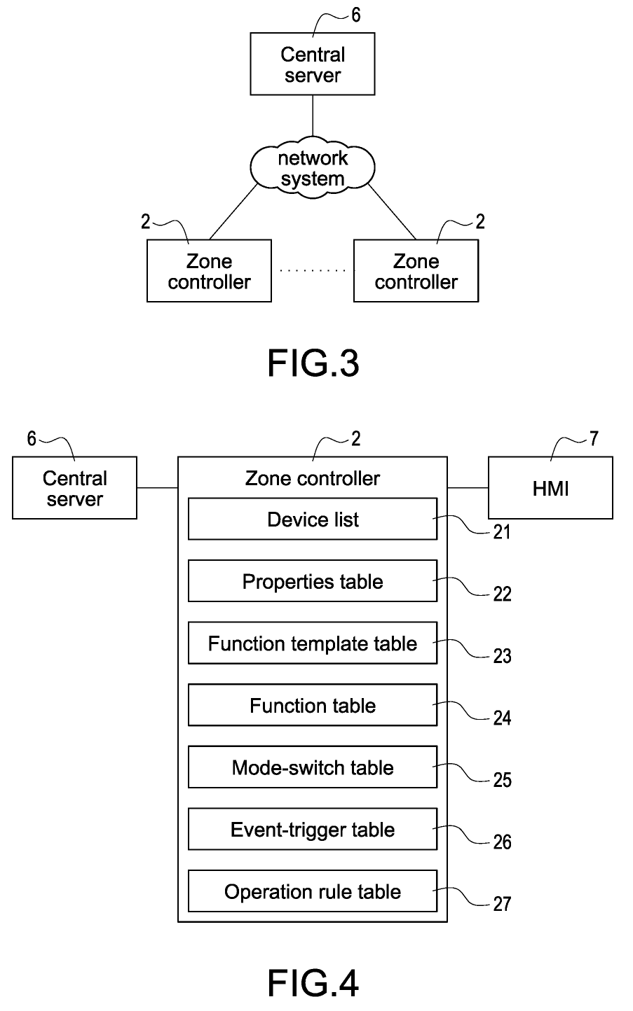

FIG. 3 is a control system schematic diagram of the third embodiment according to the present invention. In the embodiment, the ZC 2 is disposed in the indoor space 1 of a building (not shown in diagram). In particular, the building has a plurality of the indoor space 1, and a control system set consisting of the ZC 2, the plurality of sensors 3, the plurality of apparatus controllers 4 and the plurality of indoor apparatuses 5 respectively disposed in each indoor space 1. Thus, the environment comfort level in the plurality of indoor spaces 1 is respectively controlled and improved via the plurality of control system sets.

As shown in FIG. 3, the building has a central server 6. The central server 6 connects to the plurality of ZCs 2 disposed in the building via a network system. The central server 6 collects the environment status in each indoor space 1. In an embodiment, an administrator of the building performs a control operation via the central server 6. Each ZC 2 determines if each ZC 2 needs to switch mode according to the sense data from the plurality of sensors 3 and the logic operation result of the control operation from the central server 6.

FIG. 4 is a zone controller block diagram of the first embodiment according to the present invention. As shown in the diagram, the ZC 2 in the embodiment connects to a Human Machine Interface (HMI) 7 via a wired or wireless connection, accepts the instruction sent by the HMI 7, and sends the data such as the sense data of the plurality of sensors 3 and the current using operation mode to the HMI 7 to store or display thereto. Therefore, a user can operate the ZC 2 and receives related information of the indoor space 1 via the HMI 7. The HMI 7 for example is a keyboard, mouse, screen set or touch control screen, or web interface wirelessly connected to the ZC 2, and the scope is not limited thereto.

In the embodiment, the users perform a set up operation via the HMI 7. The ZC 2 determines if the ZC 2 needs to switch mode according to the sense data from the plurality of sensors 3 and the logic operation result of the set up operation of the HMI 7. It should be noted that, the ZC 2 receives the sense data from the plurality of sensors 3, accepts the control operation from the central server 6, and accepts the set up operation from the HMI at the same time in a preferred embodiment. Also, the ZC 2 determines if the ZC 2 needs to switch mode according to the sense data, the control operation and the logic operation result of the set up operation. Nonetheless, the above mentioned embodiments are preferred embodiments according to the present invention, and the scope is not limited thereto.

As shown in FIG. 4, the ZC 2 has a device list 21. A device code of the plurality of sensors 3 and the plurality of apparatus controllers 4 which are required to connect to the ZC 2 in the indoor space 1 is recorded in the device list 21 (detailed in the following).

The ZC 2 comprises a mode-switch table 25 and an event-trigger table 26. In the embodiment, the ZC 2 inquires the mode-switch table 25 and the event-trigger table 26 according to the sense data for determining if the ZC 2 needs to switch the operation mode.

The ZC 2 also comprises an operation rule table 27. In the embodiment, the ZC 2 retrieves a plurality of operating rules for the current using operation mode from the operation rule table 27, and performs the corresponding operation on each apparatus controller 4 according to the operating rules. Wherein, each operating rule respectively comprises one or multiple functions required to be executed under the operation mode by the ZC 2 and each apparatus controller 4, and the execution way of the functions (for example, execute once or many times).

The ZC 2 also comprises a properties table 22 and a function template table 23. In the embodiment, properties of the ZC 2, each sensor 3 and each apparatus controller 4 are recorded in the properties table 22. Function templates provided by the ZC 2 and each apparatus controller 4 are recorded in the function template table 23.

The ZC 2 also comprises a function table 24. In the embodiment, users understand the plurality of functions template provided by the ZC 2 and each apparatus controller 4 via the function template table 23, and select one or multiple required function templates, and the selected function templates are recorded in the function table 24. In other words, a plurality of function templates provided by the ZC 2 and each apparatus controller 4 which is required or not necessarily required by the users are recorded in the function template table 23. When the function templates are selected by the users and stored in the function table 24, the function templates are used as a plurality of functions to be respectively executed by the ZC 2 or each apparatus controller 4 in the control system.

It should be noted that when the users set up the operation rule table 27, the users are allowed to only select from the plurality of functions in the function table 24 instead of selecting from the plurality of function templates recorded in the function template table 23.

As mentioned above, users create the content of the mode-switch table 25, the event-trigger table 26 and the operation rule table 27 with references to the properties table 22, the function template table 23 and the function table 24 (detailed in the following).

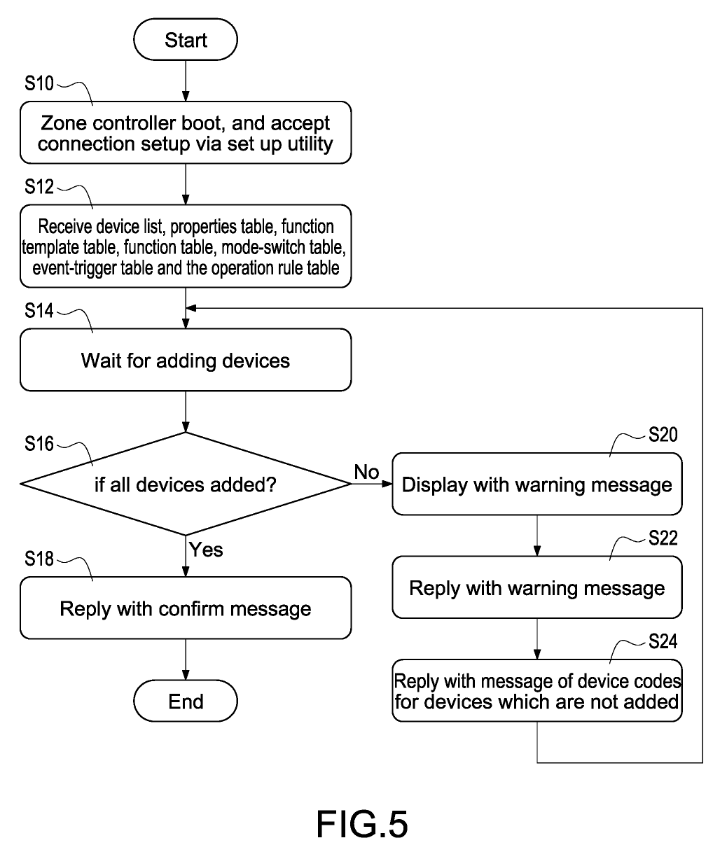

FIG. 5 is a zone controller booting flowchart of the first embodiment according to the present invention. After the ZC 2 is disposed, the ZC 2 first boots, and accepts a connection setup by the administrator via a set up utility (not shown in diagram) (step S10). In the embodiment, the set up utility for example is a notebook computer or a smart phone which wirelessly connects to the ZC 2 after booting, and sets up as required on the ZC 2, and transmits required data to the ZC 2.

After the step S10, the ZC 2 receives the above mentioned device list 21, the properties table 22, the function template table 23, the function table 24, the mode-switch table 25, the event-trigger table 26 and the operation rule table 27 from the set up utility (step S12). In an embodiment, the function table 24, the mode-switch table 25, the event-trigger table 26 and the operation rule table 27 is blank before the users' setup. In another embodiment, the users fine tune the predetermined tables 24-27, and the scope is not limited thereto.

Next, the ZC 2 waits for adding the sensors 3 and the apparatus controller 4 in the indoor space 1 (step S14). In particular, the ZC 2 waits and accepts the sensor 3 and the apparatus controller 4 recorded in the device list 21 to proactively send a connection request, and permits the sensor 3 and the apparatus controller 4 sending the connection request to add to a control group created by the ZC 2.

In the embodiment, the device codes of all or part of the sensor 3 and the apparatus controllers 4 in the indoor space 1 are recorded in the device list 21, which is provided to the ZC 2 for determining if the ZC 2 accepts the connection request, but the scope is not limited thereto.

Next, the ZC 2 determines if all the devices recoded in the device list 21 are added to the control group (step S16). When all the recorded devices in the device list 21 are added to the control group, the ZC 2 replies with a confirm message to the HMI 7 or/and the central server 6 (step S18). Thus, the users or the administrator is notified about the boot and set up procedures of the ZC 2 are completed, and the ZC 2 is ready to execute the automatic control method.

If the step S16 determines that not all the devices recorded in the device list 21 added to the control group, the ZC 2 displays a warning message (step S20). For example, the ZC 2 displays text or picture warning message on an LED display or a screen, or generate audio warning message with buzzers. At the same time, the ZC 2 replies with the warning message to the HMI 7 or/and the central server 6 (step S22), and replies with the device codes of all devices not added to the control group to the HMI 7 or/and the central server 6 (step S24). Therefore, the users or the administrator performs a debug to complete the boot and set up procedure of the ZC 2.

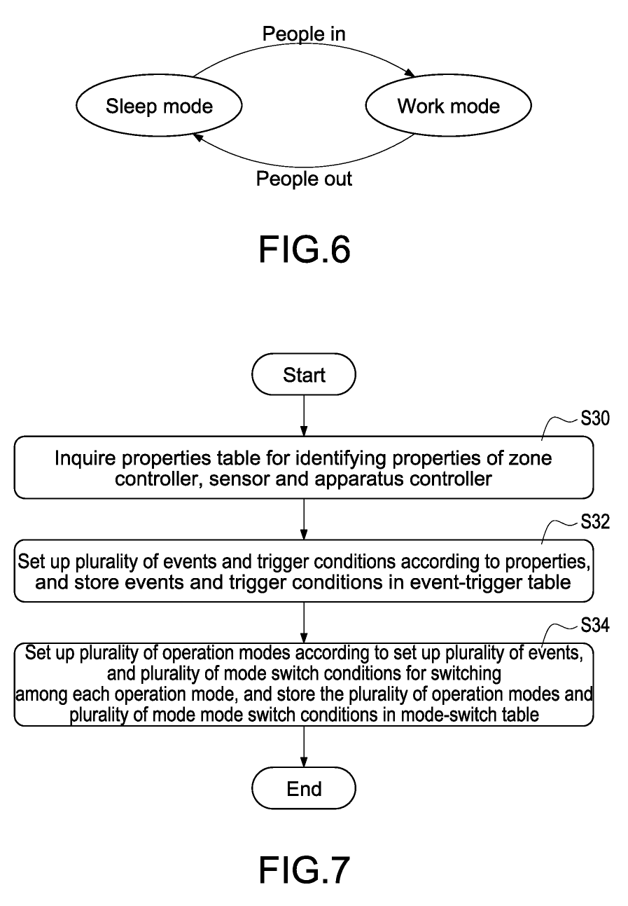

FIG. 6 is a mode switch schematic diagram of the first embodiment according to the present invention. The ZC 2 automatically determines if the ZC 2 switches from the current using operation mode according to the mode-switch table 25 and the event-trigger table 26. In the embodiment in FIG. 6, if the ZC 2 operates under a sleep mode, the ZC 2 automatically switches to a work mode when a person enters the room. Similarly, if the ZC 2 operates under the work mode and a person leaves the room, the ZC 2 automatically switches to the sleep mode.

As mentioned above in the embodiment, the ZC 2 inquires the event-trigger table 26 based on the received feedback data (for example at least one of the sense data, the set up operation and the control operation) for determining if any predetermined event is triggered. When any event is triggered, the ZC 2 inquires the mode-switch table 25 with the triggered event for determining if the triggered event matches with any predetermined mode switch condition. When any predetermined mode switch conditions is matched, the ZC 2 automatically switches from the current using operation mode to another operation mode corresponding to the matched mode switch condition.

The following table is an example of the event-trigger table 26:

Event Trigger condilion

E1 The logic operation result of the feedback data matches with the first result

E2 The logic operation result of the feedback data matches with the second result

E3 The logic operation result of the feedback data matches with the third result

E4 The logic operation result of the feedback data matches with the fourth result

E5The logic operation result of the feedback data matches with the fifth result

Event-Trigger Table

As shown in the above table, the event-trigger table 26 is predefined with a plurality of events and a trigger condition for each event, wherein the trigger condition is a judgment of whether the logic operation result of one or multiple entries of the feedback data received by the ZC 2 matches with a predetermined result.

For example, the feedback sense data of the sensor 3 which show a person enters the indoor space 1 matches with the first result and triggers an event E1; the users performing the set up operation via the HMI 7 for setting up required temperature matches with the second result and triggers an event E2; the central server 6 performing the control operation for controlling the ZC 2 to adjust the temperature matches with the third result and triggers an event E3; the central server 6 performing the control operation for controlling the ZC 2 to return to a standby mode matches with the fourth result and triggers an event E4; the feedback sense data of the plurality of sensors 3 which shows that no one is in the indoor space 1 matches with the fifth result and triggers an event E5. Though, the above mentioned embodiments are preferred embodiments according to the present invention, and the scope is not limited thereto.

Specifically, the following table 1 is an example of the event-trigger table 26 in the embodiment shown in FIG. 6:

TABLE 1

| Event | Trigger condition |
|---|---|
| E_PI | PD1.STATUS or PD2.STATUS |
| E_PO | !PD1.STATUS and !PD2.STATUS |

As shown in Table 1 and the embodiment shown in FIG. 6, when the status of PD1 or the PD2 (PD2) is 1 (i.e., triggered), the ZC 2 determines an event E_PI (People In) is triggered; on the other hand, when the status of the PD1 and the PD2 are both not 1, the ZC 2 determines an event E_PO (People Out) is triggered.

With the plurality of trigger conditions recorded in the event-trigger table 26, the ZC 2 determines if the current environment status in the indoor space 1 triggers any predetermined event. Whereby, the ZC 2 further determines if the triggered event matches with any mode switch condition in the mode-switch table 25.

The following table is an example of the mode-switch table 25:

Mode-switch table

| | | Mode switch |
|---|---|---|
| Original mode | Target mode | conditions |
| Standby mode | The first work mode | E1 triggered |
| The first work mode | The second work mode | E2 or E3 triggered |
| The second work mode | Standby mode | E4 triggered |
| The first work mode | Standby mode | E5 triggered |

As described above, a plurality of original modes, a plurality of target modes, and a plurality of mode switch conditions for respectively switching from each original mode to each target mode are recorded in the mode-switch table 25 according to users' setup.

In the embodiment, when any above mentioned event is triggered, the ZC 2 first obtains the mode switch condition and the target mode corresponding to the current using original mode from the mode-switch table 25, and determines if the triggered event matches with the corresponding mode switch condition. When the triggered event matches with the corresponding mode switch condition, the ZC 2 automatically switches from the current using original mode to the corresponding target mode.

For example, when the ZC 2 operates under a standby mode and the event E1 is triggered, the ZC 2 automatically switches to the first work mode; when the ZC 2 operates under the first work mode and the event E2 or E3 is triggered, the ZC 2 automatically switches to the second work mode; when the ZC 2 operates under the first work mode and the event E5 is triggered, the ZC 2 automatically switches to the standby mode; when the ZC 2 operates under the second work mode and the event E4 is triggered, the ZC 2 automatically switches to the standby mode.

The following table 2 is an example of the mode-switch table in the embodiment shown in FIG. 6:

TABLE 2

| | | Mode switch |
|---|---|---|
| Original mode | Target mode | conditions |
| Sleep mode | Work mode | E_PI |
| Work mode | Sleep mode | E_PO |

As shown in Table 2, in the embodiment in FIG. 6, when the ZC 2 operates under the sleep mode and the event E_PI is triggered (people enters the indoor space 1), the ZC 2 automatically switches to the work mode. When the ZC 2 operates under the work mode and the event E_PO is triggered (people leaves the indoor space 1), the ZC automatically switches to the sleep mode. The above mentioned embodiments are preferred embodiments according to the present invention, and the scope is not limited thereto.

FIG. 7 is a table set up flowchart of the first embodiment according to the present invention. When executing the boot and set up procedures, the ZC 2 receives the mode-switch table 25 and the event-trigger table 26 from the set up utility, and the content of the mode-switch table 25 and the event-trigger table 26 is self-configurable via the method described below by the users.

Firstly, the users connect to the ZC 2 via the HMI 7, and perform the set up operation for inquire the properties table 22 for identifying properties of the ZC 2, each sensor 3 and each apparatus controller 4 (step S30). In particular, the following table is an example of the properties table 22:

Properties table

| Component | Properties | Data type | Read/Write |
|---|---|---|---|
| PD1 | STATUS | Boolean | Read Only |
| PD2 | STATUS | Boolean | Read Only |
| TH1 | TEMPERATURE | Float | Read Only |
| TH1 | HUMIDITY | Float | Read Only |
| FC1 | VALVE | Boolean | Both |
| FC1 | FAN_SPEED | Integer | Both |
| FC2 | VALVE | Boolean | Both |
| FC2 | FAN_SPEED | Integer | Both |
| LC1 | STATUS | Boolean | Both |
| LC2 | STATUS | Boolean | Both |
| ZC | OPT_T | Float | Both |
| ZC | OPT_H | Float | Both |
| ZC | PMV | Float | Both |

As mentioned in the above table, the users obtain the properties of the ZC 2, each sensor 3 and each apparatus controller 4 from the properties table 22.

For example, the properties of the PD1 and the PD2 are STATUS, the data types of the PD1 and the PD2 are Boolean (i.e. 0 or 1), the Read/Write authorities of the PD1 and the PD2 are restricted to Read Only; the properties of the first TH sensor (TH1) are temperature (TEMPERATURE) and humidity (HUMIDITY), the data type of the first TH sensor (TH1) is Float, the Read/Write authority of the first TH sensor (TH1) is restricted to Read Only; the properties of the first fan controller (FC1) and the second fan controller (FC2) are VALVE and FAN_SPEED, the data type of the VALVE is Boolean and the data type of FAN_SPEED is Integer, the Read/Write authorities of the first fan controller (FC1) and the second fan controller (FC2) are restricted to Read and Write (Both); the properties of the first light controller (LC1) and the second light controller (LC2) are STATUS, the data types of the first light controller (LC1) and the second light controller (LC2) are Boolean, the Read/Write authorities of the first light controller (LC1) and the second light controller (LC2) are restricted to Read and Write (Both); the properties of the ZC 2 are the optimal temperature (OPT_T), the optimal humidity (OPT_H) and the optimal comfort level (Predicted Mean Vote, PMV), the data type of the ZC 2 is Float, the Read/Write authority of the ZC 2 is restricted to Read and Write (Both). The above mentioned embodiments are preferred embodiments according to the present invention, and the scope is not limited thereto.

After the step S30, the users set up the plurality of events, and the trigger condition of each event, according to the properties of each component, and store the events and the trigger conditions in the event-trigger table 26 (step S32). After the plurality of events and the plurality of trigger conditions are set up, the users further set up the plurality of operation modes (i.e., the plurality of original modes and the plurality of target modes) according to the set up plurality of events, and a plurality of mode switch conditions for switching among each operation mode, and store the plurality of operation modes and the plurality of the mode switch conditions in the mode-switch table 25 (step S34).

As mentioned above, when the ZC 2 operates under any operation mode, the ZC 2 performs the corresponding operation on each apparatus controller 4 according to a plurality of operating rules recorded in the operation rule table 27. In particular, one or multiple functions and execution ways of the functions required executing by the ZC 2 and each apparatus controller 4 under the operation mode are recorded in the operation rule table 27. The functions are selected by the users with reference to the function template table 23 and recorded in the function table 24.

In an embodiment, the following table is an example of the function template table 23:

Function template table

| Component | Function template | Input | Output |
|---|---|---|---|
| FC1 | INIT_FUZZY_CON- | Current | NONE |
| | TROL | temperature | |
| FC1 | FUZZY_CONTROL | Current | FAN_SPEED, |
| | | temperature | FAN_VALVE |
| FC2 | INIT_FUZZY_CON- | Current | NONE |
| | TROL | temperature | |
| FC2 | FUZZY_CONTROL | Current | FAN_SPEED, |
| | | temperature | FAN_VALVE |
| ZC | PMV | Current | PMV |
| | | temperature, | |
| | | current | |
| | | humidity | |
| ZC | OPT_T and OPT_H | Current | OPT_T, |
| | | temperature | OPT_H |

As mentioned in the above table, take the FC1, the FC2 and the ZC 2 for examples, the FC1 and the FC2 both have the function template of the Initial Fuzzy Control (INIT_FUZZY_CONTROL) having the input parameter of the Current Temperature and do not have the output parameters (NONE). Alternatively, the FC1 and the FC2 both have the function template of the Fuzzy Control (FUZZY_CONTROL) having input parameter of the Current Environment Temperature and the output parameters of the Fan Speed (FAN_SPEED) and the Fan Valve Status (FAN_VALVE). The ZC 2 has the function templates of the Calculating Optimal Comfort Level (PMV), having the input parameters of the Current Environment Temperature and the Current Environment Humidity (Current Humidity), and the output parameters of the PMV. The ZC 2 also has function templates of the Calculating Optimal Temperature (OPT_T) and the Optimal Humidity (OPT_H), having the input parameters of the Currently Environment Temperature, and the output parameters of the Optimal Temperature and the Optimal Humidity.

With references to the function template table 23, users select one out of one or multiple function templates and recorded the selected one or multiple function templates in the function table 24, wherein the ZC 2 and each apparatus controller 4 under each operation mode execute the functions included in the function table 24. The following table is an example of the function table 24:

Function table

| FunctionID | Component | Function | Input | Output |
|---|---|---|---|---|
| Function1 | FC1 | INIT_FUZZY_CONTROL | ZC.OPT_T | NONE |
| Function2 | FC1 | FUZZY_CONTROL | TH1.TEMPERATURE | FAN1_SPEED |
| | | | | FAN1_VALVE |
| Function3 | FC2 | INIT_FUZZY_CONTROL | ZC.OPT_T | NONE |
| Function4 | FC2 | FUZZY_CONTROL | TH1.TEMPERATURE | FAN2_SPEED |
| | | | | FAN2_VALVE |
| Function5 | ZC | PMV | TH1.TEMPERATURE, | PMV |
| | | | TH1.HUMIDITY | |
| Function6 | ZC | OPT_T and OPT_H | TH1.TEMPERATURE | OPT_T, OPT_H |

As mentioned in the above table, all function templates of the function template table 23 are recorded in the function table 24 by the users to be the executable functions in the embodiment.

The function with a Function ID of the Function 1 is execute by the FC1, where the executing function is the Initial Fuzzy control, having the input parameter of the Optimal Temperature (ZC.OPT_T) of the ZC 2, and it does not have the output parameter. The function with a Function ID of the Function 2 is also executed by the FC 1, where the executing function is the Fuzzy Control, having the input parameters the TH1 of Sense Temperature (TH1.TEMPERATURE), having the output parameters of the FAN_SPEED and the VALVE STATUS of the first fan (FAN1).

The function with a Function ID of the Function 3 is execute by the FC2, where the executing function is the Initial Fuzzy Control, having the input parameter of the Optimal Temperature of the ZC 2 (ZC.OPT_T), and it does not have the output parameter. The function with a Function ID of the Function 4 is also execute by the FC2, where the executing function is the Initial Fuzzy Control, having the input parameter of the Sense Temperature of the TH1 (TH1.TEMPERATURE), having the output parameters of the FAN_SPEED and the VALVE STATUS of the second fan (FAN2).

The function with a Function ID of the Function 5 is execute by the ZC 2, where the executing function is the Calculating Optimal Comfort Level (PMV), having the input parameters of the Sense Temperature and Sense Humidity of TH1, having the output parameter of the Optimal Comfort Level (PMV). The function with a Function ID of the Function 6 is execute by the ZC 2, where the executing function is the Calculating Optimal Temperature (OPT_T) and Optimal Humidity (OPT_H), having the input parameter of the Sense Temperature of the TH1 (TH1.TEMPERATURE), having the output parameters of the Optimal Temperature (OPT_T) and Optimal Humidity (OPT_H). The above mentioned is an embodiment according to the present invention.

After the function table 24 is created, the users are allowed to match specific function(s) to specific operation mode, and set up each execution way of each function under the operation mode, and store the above matching associations in the operation rule table 27. The following table is an example of the operation rule table 27:

Operation rule table

| Operation mode | FunctionID | Execution ways |
|---|---|---|
| Work Mode | Function1 | One |
| Work Mode | Function2 | Repeat |
| Work Mode | Function3 | One |
| Work Mode | Function4 | Repeat |
| Work Mode | Function5 | Repeat |
| Work Mode | Function6 | One |

As mentioned in the above table, the ZC 2 retrieves a plurality of functions corresponding to the current using operation mode, and the execution ways of each function from the operation rule table 27. Before exit the operation mode, the ZC 2 continues to execute the function according to the execution ways. Take the above table as an example, when the ZC 2 operates under the work mode, the ZC 2 execute the Function 1, the Function 3 and the Function 6 once, and before exit the work mode, the ZC 2 continues to repeat executing the Function 2, the Function 4 and the Function 5. The work mode is used as an example in the embodiment, however, the operation rule table 27 is used for setting up and recording the functions under all operation modes and the execution ways according to the users' operation (for example, operate via the HMI 7), and the scope is not restricted to the above mentioned example only.

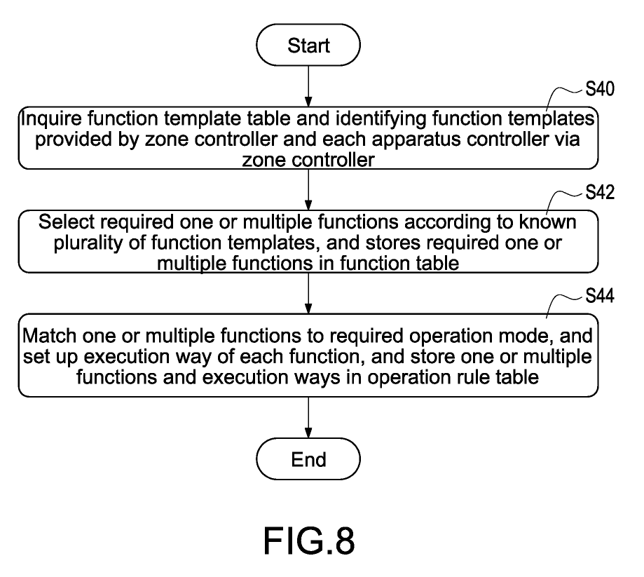

FIG. 8 is a table set up flowchart of the second embodiment according to the present invention. In the embodiment, the users set up the function table 24 and the operation rule table 27 via the HMI 7.

Firstly, the users connects to the ZC 2 via the HMI 7, and performs the set up operation to inquire the function template table 23 and identifying function templates provided by the ZC 2 and each apparatus controller 4 via the ZC 2 (step S40). Next, the users select the required one or multiple functions according to the known plurality of function templates, and store the required one or multiple functions in the function table 24 (step S42). Specifically, the users select the required function, and set up the Function ID, the input parameters and the output parameters of the function, then store the Function ID, the input parameters and the output parameters of the function in the function table 24.

Next, the users respectively match the one or multiple functions recorded in the function table 24 to the required operation modes, and set up the execution ways of each function under each operation mode, and store the one or multiple functions and the execution ways of each function under each operation mode in the operation rule table 27(step S44).

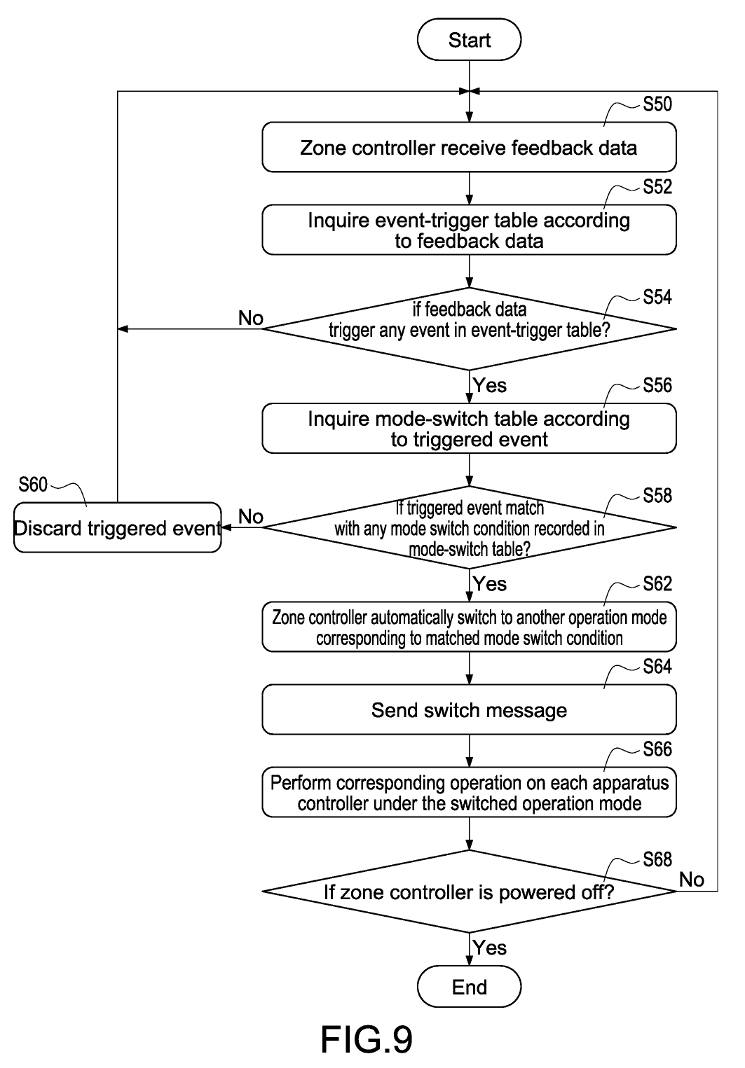

FIG. 9 is an automatic control flowchart of the first embodiment according to the present invention. After the ZC 2 boots and the users set up the function table 24, the mode-switch table 25, the event-trigger table 26 and the operation rule table 27, the ZC 2 executes automatic control method according to the present invention.

Firstly, the ZC 2 receives the feedback data transmitted from each device (step S50). In the embodiment, the feedback data for example is the sense data of the plurality of sensors 3, the set up operation of the HMI 7 or the control operation of the central server 6, etc., and the scope is not limited thereto.

After the step S50, the ZC 2 inquires the event-trigger table 26 and the mode-switch table 25 according to the received feedback data for determining if the feedback data matches with one of the predetermined mode switch conditions.

In particular, the ZC 2 firstly inquires the event-trigger table 26 according to the feedback data (step S52), for determining if the feedback data triggers any event in the event-trigger table 26 (step S54). In other words, the ZC 2 determines if the feedback data matches with trigger condition of any event recorded in the event-trigger table 26. If the feedback data does not trigger any event, the method flow returns to the step S50, the ZC 2 continues to receive the feedback data and determine if the ZC 2 needs to switch the operation mode.

If the judgment is YES in the step S54, the ZC continues to inquire the mode-switch table 25 according to the triggered event (step S56), and determines if the triggered event matches with any mode switch condition recorded in the mode-switch table 25 (step S58). In particular, the ZC 2 first obtains the mode switch condition corresponding to the current using original mode from the mode-switch table 25, and determines if the triggered event matches with the mode switch condition.

If the judgment is NO in the step S58, that the judgment shows the triggered event does not match with the mode switch condition for switching from the current using original mode to the target mode. Under the circumstance, the ZC 2 discards the triggered event (step S60), and the method flow returns to the step S50 to continue receiving the feedback data and determining if the ZC 2 needs to switch the mode.

If the judgment is YES in the step S58, the ZC 2 automatically switches to another operation mode corresponding to the matched mode switch condition (step S62). More specifically, the ZC 2 switches from the current using original mode to the target mode corresponding to the matched mode switch condition.

In a preferred embodiment, after the mode switching, the ZC 2 sends a switch message to the HMI 7 or/and the central server 6 (step S64). Thus, the users or the administrators are notified about the current using operation mode of the ZC 2.

After the ZC 2 switched the operation mode, the ZC 2 operates under the switched operation mode, and performs corresponding operations on each apparatus controller 4 under the switched operation mode (step S66).

The ZC 2 also determines if the ZC 2 is powered off (step S68), and repeats executing the above mentioned steps S50 to S66 to continue the automatic control method before the ZC 2 is powered off.

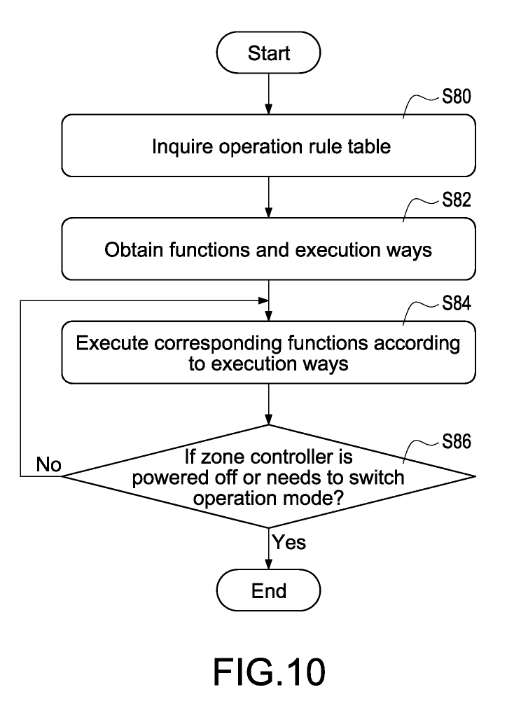

FIG. 10 is an automatic operation flowchart of the first embodiment according to the present invention. When the ZC 2 operates under a specific operation mode, the ZC 2 first inquires the operation rule table 27 (step S80) in order to obtain one or multiple functions and execution ways of each function which the ZC 2 requires to execute under the operation mode (step S82). Next, the ZC 2 respectively executes corresponding function according to the execution ways (step S84).

The ZC 2 also determines if the ZC 2 is powered off or needs to switch operation mode (step S86), and before the ZC 2 is powered off or needs to switch operation mode, the ZC 2 repeats executing the above mentioned step S84 in order to continue executing respectively the corresponding function according to the execution ways. It should be noted that, when the ZC 2 switches from an original mode to a target mode, the ZC 2 stops executing the functions used by the original mode, and starts to execute the functions recorded in the target mode according to the execution ways recorded in the target mode.

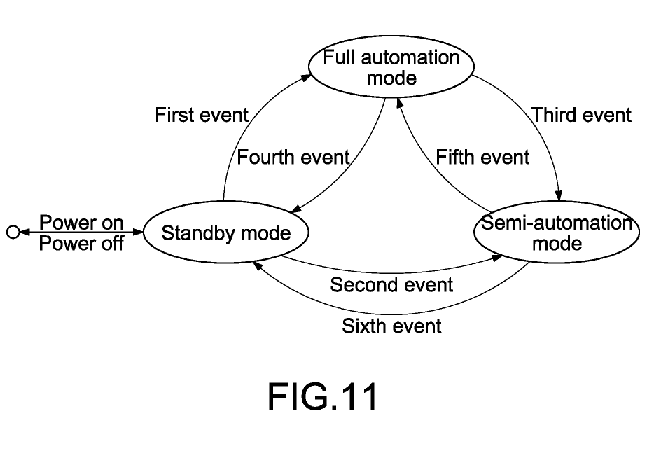

FIG. 11 is a mode switch schematic diagram of the second embodiment according to the present invention. In the embodiment shown in FIG. 11, the ZC 2 has a standby mode, a full automation mode and a semi-automation mode. Among which, the ZC 2 boots but does not perform any operation under the standby mode; the ZC 2 automatically determines and executes all operations under the full automation mode; the ZC 2 automatically determines and executes part of the operations according to the administrators or the users' operation under the semi-automation mode.

In the embodiment in FIG. 11, after the ZC 2 boots, the ZC 2 operates under the standby mode. When the ZC 2 operates under the standby mode and the first event occurs, the ZC 2 switches from the standby mode automatically to the full automation mode; when the ZC 2 operates under the standby mode and the second event occurs, the ZC 2 switches from the standby mode automatically to the semi-automation mode.

As mentioned above, the first event for example is that each sensor 3 senses people enters the indoor space 1, the central server 6 instructs the ZC 2 to enter into the full automation mode according to the control operation, or the HMI 7 instructs the ZC 2 to enter into the full automation mode according to the set up operation, etc. The second event for example is that the ZC 2 accepts the control operation or the set up operation, and modifies part of the setup of the ZC 2.

When the ZC 2 operates under the full automation mode and the third event occurs, the ZC 2 switches from the full automation mode automatically to the semi-automation mode; when the ZC 2 operates under the full automation mode and the fourth event occurs, the ZC 2 returns from the full automation mode to the standby mode.

As mentioned above, the third event for example is that the ZC 2 accepts the control operation or the set up operation, and modifies part of set up of the ZC 2. The fourth event for example is that each sensor 3 senses all people left the indoor space 1, the central server 6 instructs the ZC 2 to return to the standby mode according to the control operation, or the HMI 7 notifies the ZC 2 that all people left the indoor space 1 according to the set up operation, etc.

When the ZC 2 operates under the semi-automation mode and the fifth event occurs, the ZC 2 switches from semi-automation mode automatically to the full automation mode; when the ZC 2 operates under the semi-automation mode and the sixth event occurs, the ZC 2 returns from the semi-automation mode to the standby mode.

As mentioned above, the fifth event for example is that the HMI 7 instructs the ZC 2 to enter into a green mode according to the set up operation, or the central server 6 instructs the ZC 2 to enter into the full automation mode according to the control operation, etc. The sixth event for example is that each sensor 3 senses all people left the indoor space 1, the central server 6 instructs the ZC 2 to return to the standby mode according to the control operation, or the HMI 7 notifies the ZC 2 that all people left the indoor space 1 according to the set up operation, etc.

With the technical solutions according to the present invention, users are capable of setting up operation modes of the ZC 2 by themselves for setting the judgment parameters used for determining if the ZC 2 should switch operation mode, and users also are capable of setting up the required operating rules under each operation mode of the ZC 2. Therefore, provide a more useful and practical ways to operate the ZC 2.

As the skilled person will appreciate, various changes and modifications can be made to the described embodiment. It is intended to include all such variations, modifications and equivalents which fall within the scope of the present invention, as defined in the accompanying claims.

What is claimed is:

1. An automatic control method for zone controller, the zone controller (ZC) disposed in an indoor space, and connected to a plurality of sensors and a plurality of apparatus controllers in the indoor space, the automatic control method comprising:
a) respectively receiving sense data from the plurality of sensors;
b) inquiring an event-trigger table and a mode-switch table for determining if the sense data matches with a predetermined mode switch condition;
c) if the sense data matches with the mode switch condition, automatically switching to an operation mode corresponding to the mode switch condition; and
d) executing corresponding operation to each apparatus controller under the operation mode, wherein each apparatus controller respectively connects to and controls multiple indoor apparatuses in the indoor space.

2. The automatic control method for zone controller of claim 1, wherein the step b comprises the following steps:
b1) determining if the sense data matches with a trigger condition of any event by inquiring the event-trigger table through the sense data;
b2) if the sense data matches with the trigger condition of an event, inquiring the mode-switch table according to the triggered event for determining if the triggered event matches with the mode switch condition.

3. The automatic control method for zone controller of claim 2, wherein a plurality of the events and the trigger condition of each event are recorded in the event-trigger table.

4. The automatic control method for zone controller of claim 2, wherein a plurality of original modes, a plurality of target modes, and a plurality of the mode switch conditions for respectively switching from each original mode to each target mode are recorded in the mode-switch table.

5. The automatic control method for zone controller of claim 2, wherein in the step b2, the ZC obtains the mode switch condition and a target mode corresponding to a currently applied original mode from the mode-switch table, and determines if the triggered event matches with the corresponding mode switch condition; in the step c, the ZC switches from the original mode to the target mode when the triggered event matches with the corresponding mode switch condition.

6. The automatic control method for zone controller of claim 1, wherein the sensor is at least one of a temperature humidity sensor, an infrared sensor and a person detector, the indoor apparatus is at least one of an air conditioner, a fan, a light fixture and a blind, the apparatus controller is at least one of a fan controller for controlling the air conditioner or the fan, a light controller for controlling the light fixture and a shade controller for controlling the blind.

7. The automatic control method for zone controller of claim 1, wherein the step d comprises the following steps:
d1) inquiring an operation rule table according to the sense data, wherein a plurality of functions and an execution way of each function that the ZC needs to execute under the operation mode are recorded in the operation rule table;
d2) respectively executing each function according to each execution way; and
d3) continuing to execute the step d2 before existing the operation mode.

8. The automatic control method for zone controller of claim 1, wherein the ZC has a device list, a device code for the plurality of sensors and the plurality of apparatus controllers required to connect to the ZC in the indoor space are recorded in the device list.

9. The automatic control method for zone controller of claim 8, wherein the method comprises the following steps before the step a:
a01) the ZC booting and accepting a connection setup;
a02) receiving the device list, the event-trigger table and the mode-switch table;
a03) waiting and accepting adding the plurality of sensors and the plurality of apparatus controllers recorded in the device list;
a04) when all the devices recorded in the device list are added, replying with a confirm message;
a05) replying with a warning message if at least one of the devices recorded in the device list is not added; and
a06) replying with a message of the device codes for the devices which are not added;.

10. The automatic control method for zone controller of claim 1, wherein the ZC further connects to an Human Machine Interface (HMI) and accepts a set up operation of the HMI, in the step b, the ZC inquires both the event-trigger table and the mode-switch table according to the sense data and the set up operation, and determines if the sense data and a logic operation result of the set up operation matches with the mode switch condition.

11. The automatic control method for zone controller of claim 1, wherein the ZC further connects t to an Human Machine Interface (HMI) and accepts a set up operation of the HMI, and the method further comprises the following steps before the step a:
a11) identifying properties of the ZC, each sensor and each apparatus controller according to a properties table;
a12) setting up a plurality of events and a trigger condition of each event according to the properties of the ZC, each sensor and each apparatus controller, and storing the set up events and triggered conditions in the event-trigger table;
a13) setting up a plurality of the operation modes, and a plurality of the mode switch conditions for switching among each operation mode according to the set up plurality of events, and storing the plurality of the operation modes and the plurality of the mode switch conditions in the mode-switch table.

12. The automatic control method for zone controller of claim 1, wherein the ZC further connects t to an Human Machine Interface (HMI) and accepts a set up operation of the HMI, and the method further comprises the following steps before the step a:
a21) identifying a plurality of function templates provided with the ZC and each apparatus controller according to a function template table;
a22) selecting required plurality of function templates and storing the required plurality of function templates in a function table as an executable plurality of functions of the ZC and each apparatus controller; and
a23) matching each function respectively with the operation mode, and respectively setting up an execution way of each function, and storing the execution ways in an operation rule table.

13. The automatic control method for zone controller of claim 12, wherein in the step d, the ZC obtains the plurality of functions and the plurality of execution ways of the operation mode from the operation rule table, and continues to respectively execute each corresponding function according to each execution way before existing the operation mode.

14. The automatic control method for zone controller of claim 1, wherein the ZC further connects to a central server of a building and accepts a control operation of the central server, wherein the building comprises a plurality of the indoor spaces, and each indoor space respectively has one of the ZC; in the step b, the ZC inquires both the event-trigger table and the mode-switch table according to the sense data and the control operation, and determines if the sense data and a logic operation result of the control operation match with the mode switch condition.

15. An automatic control method for zone controller, the ZC disposed in an indoor space, and connected to a plurality of sensors and a plurality of apparatus controllers in the indoor space, the automatic control method comprising:
a) respectively receiving sense data from the plurality of sensors;
b) inquiring an event-trigger table according to the sense data, wherein a plurality of events and a trigger condition of each event are recorded in the event-trigger table;
c) when the sense data matches with any trigger condition of any event, inquiring a mode-switch table according to the triggered event, wherein a plurality of operation modes, and a plurality of mode switch conditions for switching among each operation mode are recorded in the mode-switch table;
d) when the triggered event matches with one of the plurality of mode switch conditions, automatically switching to the operation mode corresponding to the matched mode switch condition;
e) inquiring an operation rule table according to the sense data, wherein a plurality of functions required to execute by the ZC after the ZC switching to the operation mode, and an execution way of each function are recorded in the operation rule table; and
f) continuing to respectively execute each corresponding function according to each execution way for controlling the ZC and the plurality of apparatus controllers before existing the switched operation mode.

16. The automatic control method for zone controller of claim 15, wherein in the step d, the ZC obtains the mode switch conditions and a target mode corresponding to a currently applied original mode from the mode-switch table, and determines if the triggered event matches with one of the corresponding mode switch conditions, switches from the original mode to the corresponding target mode when the triggered event matches with one of the corresponding mode switch conditions.

17. The automatic control method for zone controller of claim 15, wherein the method comprises the following steps before the step a:
a01) the ZC booting and accepting a connection setup;
a02) receiving a device list, the event-trigger table, the mode-switch table and the operation rule table;
a03) waiting and accepting adding the plurality of sensors and the plurality of apparatus controllers recorded in the device list;
a04) when all the devices recorded in the device list are added, replying with a confirm message;
a05) displaying with a warning message if at least one of the devices recorded in the device list is not added; and
a06) replying with the warning message to a Human Machine Interface (HMI) if at least one of the devices recorded in the device list is not added; and
a07) replying with a message of the device codes for the devices which are not added to a HMI.

18. The automatic control method for zone controller of claim 15, wherein the ZC further connects to an Human Machine Interface (HMI) and accepts a set up operation of the HMI, and the method further comprises the following steps before the step a:
a11) identifying properties of the ZC, each sensor and each apparatus controller according to a properties table;
a12) setting up the plurality of events and the trigger condition of each event according to the properties of the ZC, each sensor and each apparatus controller, and storing the events and the triggered condition in the event-trigger table;
a13) setting up the plurality of operation modes, and the plurality of mode switch conditions for switching among each operation mode according to the set up plurality of events, and storing the plurality of operation modes and the plurality of mode switch conditions in the mode-switch table;
a14) identifying a plurality of function templates provided with the ZC and each apparatus controller according to a function template table;
a15) selecting required plurality of function templates and storing the required plurality of function templates in a function table as executable plurality of functions of the ZC and each apparatus controller; and
a16) matching each function respectively with each of the operation modes, and respectively setting up an execution way of each function, and storing the execution ways in the operation rule table.

19. The automatic control method for zone controller of claim 15, wherein the ZC further connects to an Human Machine Interface (HMI) and accepts a set up operation of the HMI, in the step b and the step c, the ZC inquires the event-trigger table according to both of the sense data and the set up operation, and determines if the sense data and a logic operation result of the set up operation match with the triggered condition of each event.

20. The automatic control method for zone controller of claim 19, wherein the ZC further connects to a central server of a building and accepts a control operation of the central server, wherein the building comprises a plurality of the indoor space, and each indoor space has one of the ZC; in the step b and the step c, the ZC inquires both the event-trigger table and the mode-switch table according to the sense data, the set up operation and the control operation, and determines if the sense data, the setup operation and a logic result of the control operation match with the triggered condition of each event.
